(19) United States
(12) Patent Application Publication
(10) Pub. No.: US 2009/0205721 A1
(43) Pub. Date: Aug. 20, 2009

(54) Burst Disc Replacement Apparatus

(75) Inventors: Trevor Bryan HUSBAND, Oxon (GB); Philip Alan Charles Walton, Oxon (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Witney (GB)

(21) Appl. No.: 12/370,881

(22) Filed: Feb. 13, 2009

(30) Foreign Application Priority Data
Feb. 15, 2008 (GB) 0802804.5

(51) Int. Cl. F16K 43/00; F16K 17/16

(52) U.S. Cl. 137/329.1; 137/68.23; 137/315.01

(57) ABSTRACT

A burst disc replacement apparatus (100) comprises a magazine (122) that carries a first burst disc (232) and a second burst disc (234). A flow path (104) passes through the apparatus (100) for venting fluid. The first burst disc (232) is located in the flow path (104). A translation mechanism (112, 144, 146, 200, 214, 220, 222) is arranged to move the second burst disc (234) into the flow path (104) in place of the first burst disc (232) in response to an indication that fluid pressure at one side of the first burst disc (232) has exceeded a predetermined pressure corresponding to rupture of the first burst disc (232).

The present invention relates to a burst disc replacement apparatus of the type that, for example, is used to provide relief from excessive pressure build-up in respect of cryogen vented from a superconducting magnet unit.

In the field of nuclear Magnetic Resonance Imaging (MRI), a magnetic resonance imaging system typically comprises a superconducting magnet, gradient and field coils, shim coils and a patient table. The superconducting magnet is provided in order to generate a strong uniform static magnetic field, known as the B₀ field, in order to polarise nuclear spins in an object under test.

Presently, the coils forming the superconducting magnet are made from metals that exhibit the property of superconductivity at very low temperatures. To achieve superconductivity, the superconducting magnet is therefore cooled to the very low temperatures. One known cryogen-cooled superconducting magnet unit includes a cryostat including a cryogen vessel. A cooled superconducting magnet is provided within the cryogen vessel, the cryogen vessels being retained within an outer vacuum chamber (OVC). One or more thermal radiation shields are provided in a vacuum space between the cryogen vessel and the OVC. In some known arrangements, a refrigerator is mounted in a refrigerator sock located in the cryostat, the refrigerator being provided for the purpose of maintaining the temperature of a cryogen provided in the cryogen vessel. The refrigerator also serves sometimes to cool one or more of the radiation shields. The refrigerator can be a two-stage refrigerator, a first cooling stage being thermally linked to the radiation shield in order to provide cooling to a first temperature, typically in the region of 50-80K. A second cooling stage provides cooling of the cryogen gas to a much lower temperature, typically in the region of 4-10OK.

As a result of a number of different factors, the cryogen used can become heated, for example from heating of the cryogen vessel or so-called “quenching” of superconducting wire from which the coils are formed, and hence so-called “boil-off” of the cryogen used can occur. When boil-off occurs, the pressure of the cryogen in the superconducting magnet unit, for example helium, must be limited and so pressure-release mechanisms are known typically employing a combination of valves and burst discs. Burst discs, or rupture discs as they are sometimes known, are discs having a membrane of material that serve as a barrier to fluids up to a specified pressure limit, but which break upon the specified pressure being exceeded, thereby allowing the fluid to pass therethrough. However, in respect of a superconducting magnet unit, once a burst disc has ruptured due to excessive pressure, the cryogen vessel is exposed to atmosphere, consequently risking air ingress. A service engineer must also be called in order to replace the damaged burst disc.

US patent publication no. 2005/198973 A1 relates to a burst disc configuration comprising a pair of burst discs in parallel, a first flow path coupled to a cryogen vessel extending to a first burst disc and a second flow path optionally coupleable to the cryogen vessel extending to a second burst disc. Initially, gas flow is via the first flow path to the first burst disc. When the first burst disc ruptures, the gas flow is diverted via the second flow path to the second, unperforated, burst disc. However, in order for the redirection of the gas flow to take place, a service engineer has to be notified and to attend the superconducting magnet unit in order to effect the diversion.

An alternative solution, as described in US patent publication no. 2005/088266 A1, is to provide a so-called quench valve, typically also fitted with a burst disc, the quench valve being cable of resealing itself after venting fluid due to a slight pressure increase. However, if the burst disc inside the quench valve ruptures owing to the valve failing to open, a service engineer also has to attend the superconducting magnet unit in order to replace the ruptured burst disc.

U.S. Pat. No. 6,109,042 and US 2003/127132 A1 disclose burst disc-related measures to vent cryogen using a burst disc. However, in common with the above-described techniques, these documents describe measures that require replacement of the burst disc by a service engineer following rupture of the burst disc. As will be appreciated, the need for a service engineer to attend a site where the superconducting magnet unit is deployed can be costly and can result in operators refraining from using the superconducting magnet unit until the service engineer replaces the broken burst disc. Furthermore, as mentioned above, whilst the service engineer is awaited, the cryogen vessel is exposed to the possibility of air ingress.

According to a first aspect of the present invention, there is provided a burst disc replacement apparatus comprising: a magazine carrying a first burst disc and a second burst disc; a flow path therethrough for venting fluid, the first burst disc being located in the flow path; and a translation mechanism arranged to move the second burst disc into the flow path in place of the first burst disc in response to fluid pressure at one side of the first burst disc exceeding a predetermined pressure corresponding to rupture of the first burst disc.

The translation mechanism may be triggered by a pressure response unit, for example a pressure actuator comprising a bore in which a piston is disposed. The piston may be biased and translate in response to the fluid pressure at the one side of the first burst disc exceeding the predetermined pressure corresponding to rupture of the first burst disc. The pressure response unit may be arranged to translate a cam surface. Alternatively, the translation mechanism may be triggered by an electromechanical actuator coupled to the cam surface and responsive to an electrical burst detection sensor coupled to the first burst disc.

The magazine may be arranged to carry a plurality of burst discs including the first burst disc and the second burst disc.

The magazine may be circular; the first and second burst discs may be circumferentially spaced. The first burst disc may be rotatably replaceable. The magazine may be windable. The apparatus may further comprise a mechanical stop for prevention of over-winding of the magazine.

The magazine may comprise a plurality of circumferentially extending slopes spaced between a plurality of circumferentially spaced dogs. The slopes may be arcuate.

The apparatus may further comprise a pivotable lever, the pivotable lever having a toe protrusion and a heel protrusion. The apparatus may further comprise a biasing device, the biasing device being arranged with the pivotable lever so as to urge the heel protrusion of the pivotable lever towards a periphery of the magazine. The biasing device may be a spring.

The apparatus may further comprise: an ingress port disposed on one side of the magazine; and a further biasing device arranged to urge the magazine towards the ingress port. The further biasing device may be a spring.

The pivotable lever may be arranged to cooperate with a slope of the plurality of slopes in order to overcome the further biasing device.

The further biasing device may be arranged to bias the magazine in two directions. The further biasing device may be arranged to bias the magazine axially and rotationally.

The apparatus may further comprise a backing plate disposed substantially parallel with the magazine and comprising circumferentially spaced pins extending from the backing plate to the magazine. The magazine may comprise a plurality of circumferentially spaced slots disposed opposite the backing plate for temporarily receiving the circumferentially spaced pins during replacement of the first burst disc.

The magazine may be mounted on a spindle. The spindle may be coupled to the backing plate. The further biasing device may be disposed about the spindle.

The apparatus may further comprise a pressure actuator responsive to the fluid pressure at the one side of the first burst disc exceeding the predetermined pressure corresponding to rupture of the first burst disc. The pressure actuator may be fluidly coupled to the flow path on the one side of the first burst disc.

The pressure actuator may be mechanically actuatable. The pressure actuator may comprise a piston coupled to a triggering protrusion arranged to translate linearly with the piston.

The triggering protrusion may comprise a ramped surface. The triggering protrusion may be an unlocking protrusion, for example an unlocking sear.

A reciprocating cycle of the triggering protrusion may trigger the magazine to rotate so as to replace the first burst disc with the second burst disc.

The magazine may comprise a broken circular groove to serve as the end stop.

The apparatus may further comprise: an egress port fluidly coupled to atmosphere or a fluid reclamation unit; the magazine may be sealingly coupled to the egress port.

According to a second aspect of the present invention, there is provided a magnetic resonance imaging system comprising the burst disc replacement apparatus as set forth above in relation to the first aspect of the invention.

It is thus possible to provide a burst disc replacement apparatus that obviates the need for a service engineer to attend the superconducting magnet unit every time a burst disc ruptures. Consequently, the maintenance cost associated with the superconducting magnet unit is reduced and running time of a system employing the superconducting magnet unit, for example a magnetic resonance imaging system, is extended in some circumstances. Furthermore, it is possible to provide an apparatus that minimises exposure of the cryogen vessel to air.

At least one embodiment of the invention will now be described, by way of example only, with reference to the accompanying drawings, in which:

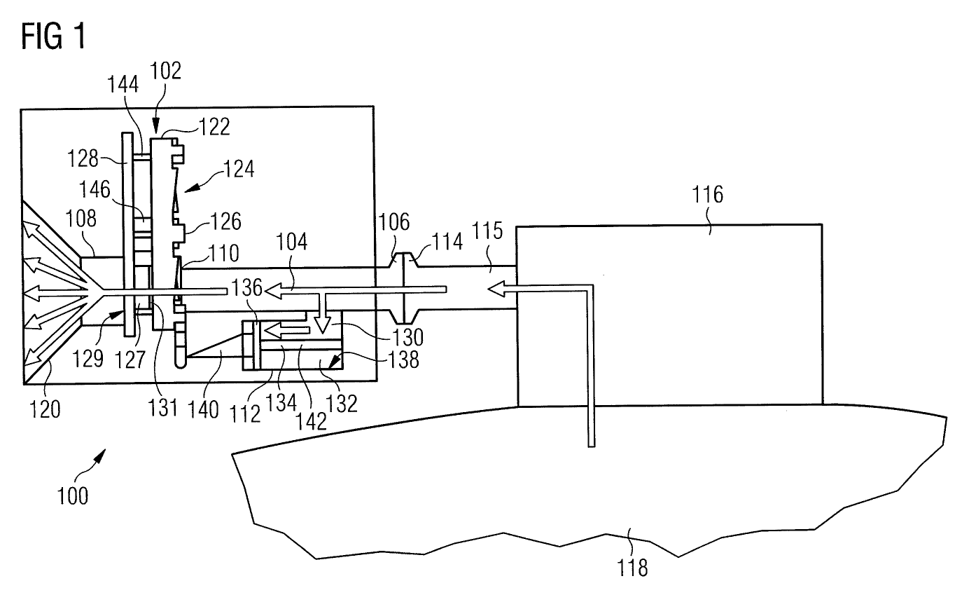

FIG. 1 is a schematic diagram of an apparatus constituting an embodiment of the invention coupled to a superconducting magnet unit;

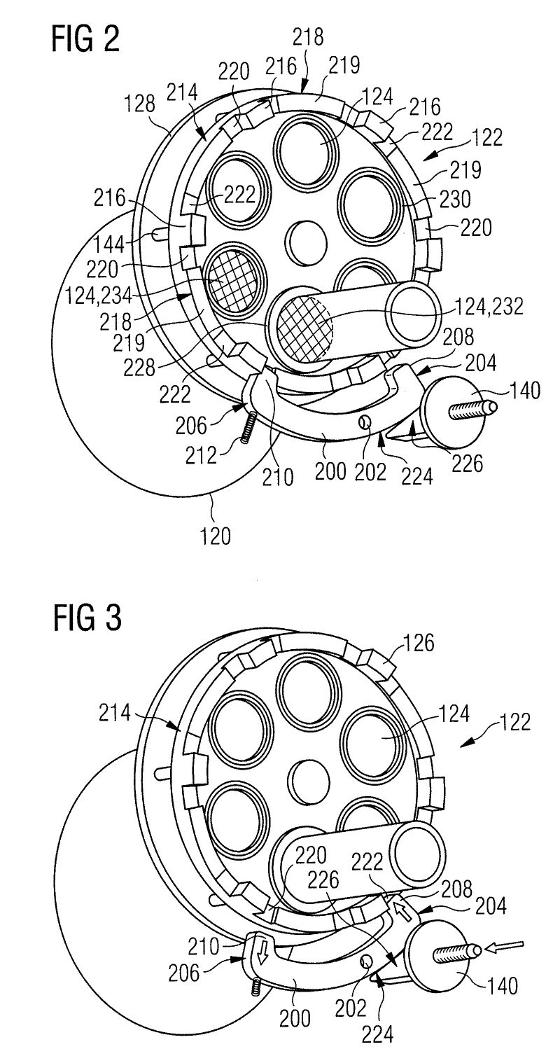

FIG. 2 is an isometric view of a first side of the apparatus of FIG. 1 at a first stage of operation;

FIG. 3 is an isometric view of the first side of the apparatus of FIG. 1 at a second stage of operation;

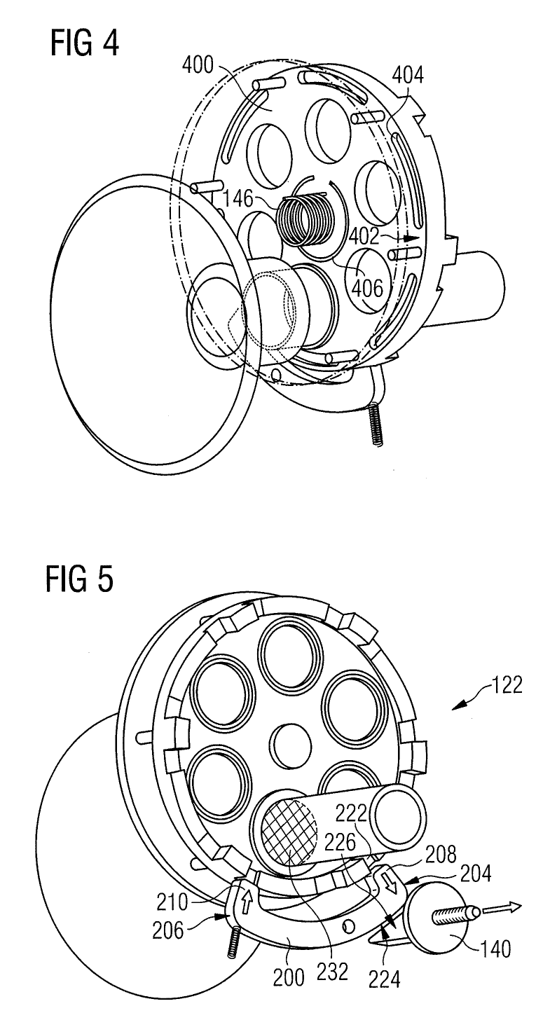

FIG. 4 is an isometric view of a second side of the apparatus of FIG. 1;

FIG. 5 is an isometric view of the first side of the apparatus of FIG. 1 at a third stage of operation;

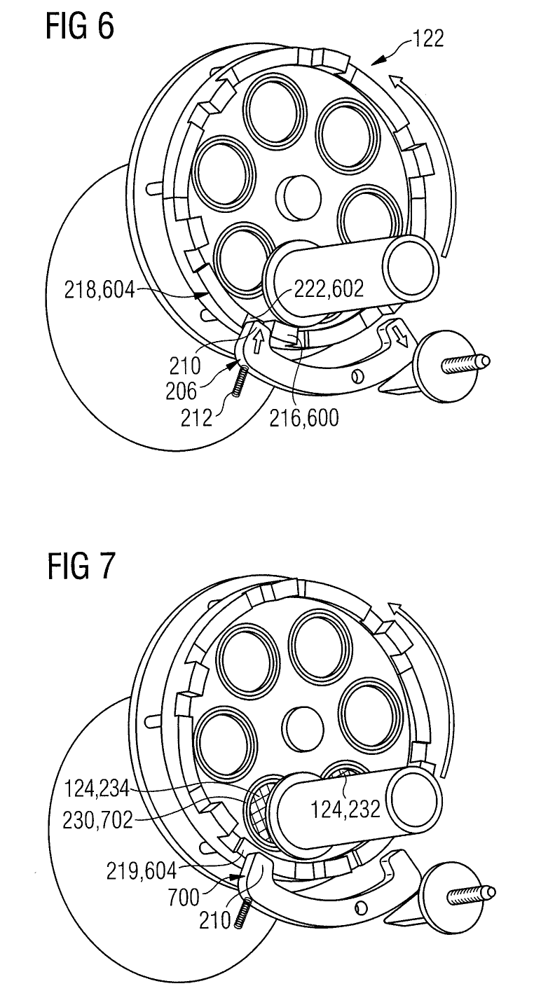

FIG. 6 is an isometric view of the first side of the apparatus of FIG. 1 at a fourth stage of operation;

FIG. 7 is an isometric view of the first side of the apparatus of FIG. 1 at a fifth stage of operation;

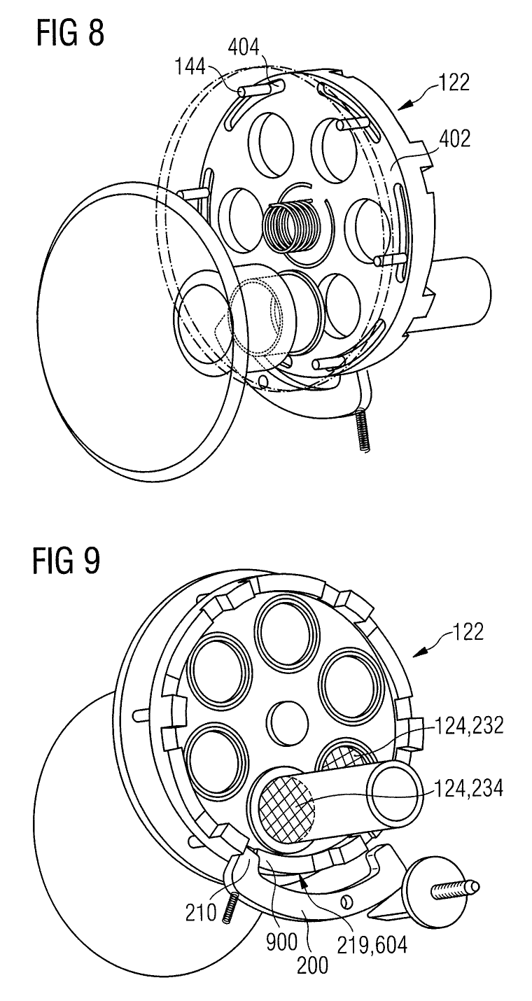

FIG. 8 is an isometric view of the second side of the apparatus of FIG. 7; and

FIG. 9 is an isometric view of the first side of the apparatus of FIG. 1 at a sixth stage of operation;

Throughout the following description identical reference numerals will be used to identify like parts.

Referring to FIG. 1, a burst disc replacement apparatus 100 comprises a burst disc changer 102 having a flow path 104 therethrough, the flow path 104 providing fluid communication between a first inlet port 106 and a first outlet port 108. The first inlet port 106 is fluidly coupled to a second inlet port 110 and a pressure actuator 112. A second outlet port 114 is coupled to an access turret 116 of a superconducting magnet unit 118 via a main vent conduit 115, the second outlet port 114 being coupled to the first inlet port 106. The first outlet port 108 is fluidly coupled via a funnel 120 to atmosphere. However, the skilled person should appreciate that the first outlet port 108 can be coupled to a cryogen reclamation unit (not shown). The superconducting magnet unit 118 comprises a cryogen vessel (not shown) containing a superconducting magnet (also not shown) located therein. The cryogen vessel is filled with a cryogen, for example liquid helium.

The burst disc changer 102 comprises a magazine 122 carrying a plurality of burst discs 124. The magazine 122 is rotatably mounted on a spindle 126, the spindle 126 being fixed to a backing plate, for example a backing disc 128. A first biasing device, for example a first spring 146, is disposed about the spindle 126 between the backing disc 128 and the magazine 122. The backing disc 128 has an aperture 129 therethrough, the aperture 129 being coupled to a biased bridging conduit 127 to provide the flow path 104 to reach atmosphere via the outlet port 108. The biased bridging conduit 127 is slidably coupled at a first end thereof to the outlet port 108 by a dynamic O-ring seal (not shown), but urged towards the magazine 122. A first O-ring seal 131 is provided at a second end of the bridging conduit 127, the first O-ring seal 131 abutting a rear face of the magazine 122 and being in registry with the second inlet port 110.

The pressure actuator 112 has a third inlet port 130 fluidly coupled to the first and second inlet ports 106, 110, and an internal chamber 132 having a piston rod 134 coupled to a piston 136 sealingly movable with respect to an internal surface 138 of the internal chamber 132. The piston 136 has a triggering protrusion, for example an unlocking sear 140, coupled thereto or integrally formed therewith. The unlocking sear 140 comprises a cam surface. The piston rod 134 is biased according to a known pressure at which the burst discs 124 are known to rupture by a second biasing device, for example a second spring 142 disposed about the piston rod 134.

A plurality of circumferentially spaced spacing pins 144 are coupled to the backing disc 128 and the magazine 122 comprises a plurality of circumferentially spaced slots (not shown in FIG. 1) for respectively receiving the spacing pins 144 on a temporary basis.

Turning to FIG. 2, burst disc replacement apparatus 100 also comprises a pivotable lever 200, or a rocker, the pivotable lever 200 being coupled to a pivot point 202 and having a toe end 204 and a heel end 206. The pivotable lever 200 is arcuate in shape and the toe end 204 thereof comprises a toe protrusion 208, for example a first tooth, extending substantially radially inwardly, and the heel end 206 comprises a heel protrusion 210, for example a second tooth, also extending substantially radially inwardly. The heel end 206 is coupled to a third biasing device, for example a third spring 212.

A periphery 214 of the magazine 122 comprises circumferential formations that extend substantially perpendicularly to a plane of the magazine 122. In this respect, the magazine 122 comprises a plurality of circumferentially spaced dogs 216 having ramped lengths 218 disposed in-between the dogs 216. In this example, the ramped lengths 218 rise from the plane of the magazine 122 in a clockwise manner to define an upper ramp surface 219, although the skilled person should appreciate that the direction in which the ramp lengths 218 rise is dependent upon the intended direction of rotation of the magazine 122. Once each ramp length 218 has risen to a maximum height, the ramp drops in a saw-tooth like manner to provide a first clearance 220 between the point of maximum height of the ramp length 218 and an adjacent dog 216. The first clearance 220 is sized to receive the toe and heel protrusions 208, 210 of the pivotable lever 200. A second clearance 222 is similarly provided between a lowest height of each ramp length 218 and an adjacent dog 216, the second clearance 222 also being sized to receive the toe and heel protrusions 208, 210 of the pivotable lever 200. The skilled person should appreciate that the above-described combination of the periphery of the magazine 122 and the pivotable lever 200 constitutes an escapement, the magazine 122 serving as an escape wheel and the pivotable lever 200 serving as an anchor.

The pivotable lever 200 also comprises a following surface 224 that abuts the ramped, cam, surface 226 of the unlocking sear 140.

The first port 106 has a peripheral sealing lip 228 and each burst disc 124 has a peripheral O-ring seal 230.

In operation, the magazine 122 is initially wound as the first spring 146 not only provides axial biasing, but also rotational biasing. The spring-tensioned magazine 122 is initially held in position by the heel protrusion 210 of the pivotable lever 200 as a result of the third spring 212 maintaining the heel protrusion 210 in the first clearance 220, thereby preventing the magazine 122 from rotating. Over-winding of the magazine is prevented by, for example, a mechanical end-stop (FIG. 4), such as an arcuate slot 406 that describes a broken circular channel formed in a rear surface 400 of the magazine 122, in combination with a pin (not shown), for example a compressible pin. The pin is carried by an opposing surface of the backing plate 128 disposed opposite the rear surface 400 of the magazine 122, the pin extending into the broken circular channel and abutting an end of the broken circular channel when rotation during winding of the magazine 122 is to be stopped.

In the event that the superconducting material, from which the superconducting magnet within the cryogen vessel is formed, quenches, a quantity of the cryogen becomes heated and changes phase, for example enters a gaseous phase and is vented via the access turret 116 as, in this example, helium gas.

Referring back to FIGS. 1 and 2, the helium gas travels along the main vent conduit 115 and builds up adjacent a first burst disc 232 disposed in the flow path 104. A volume of the helium gas also enters the internal chamber 132 of the pressure actuator 112 before reaching the first burst disc 232, the helium gas being diverted into the internal chamber 132 via the inlet port 130. Once the pressure in the main vent conduit 115 (and hence adjacent the first burst disc 232) exceeds a predetermined rated pressure associated with a point of rupture of the first burst disc 232, the first burst disc 232 ruptures and the helium gas is vented safely to atmosphere via the first outlet port 108 and the funnel 120 or to a cryogen recovery system (not shown). The pressure of gas diverted into the pressure actuator 112 also exceeds the predetermined rated pressure associated with the first burst disc 232, the second spring 142 having been selected to yield to pressures acting on the piston 136 in excess of the predetermined rated pressure associated with the first burst disc 232 (or other burst discs 124). Consequently (FIG. 3), the piston 136 and hence the unlocking sear 140 translate from a rest position towards the pivotable lever 200, causing the following surface 224 of the pivotable lever 200 to follow the ramped surface 226 of the unlocking sear 140. The toe end 204 of the pivotable lever 200 is therefore urged towards the periphery 214 of the magazine 122 and so the pivotable lever 200 pivots about the pivot point 202 and the heel end 206 of the pivotable lever 200 moves away from the periphery 214 of the magazine 122. The toe protrusion 208 therefore enters the second clearance 222 and the heel protrusion 210 withdraws from the first clearance 220 so as to disengage the heel protrusion 210 from the magazine 122.

Due to the velocity of translation of the unlocking sear 140, the geometry of the pivotable lever 200 and the sizes of the first and second clearances 220, 222 engagement of the pivotable lever 200 with the periphery 214 of the magazine 122 is transferred from the heel portion 206 to the toe portion 204 without significant rotation of the magazine 122 taking place.

Referring to FIG. 4, immediately prior to the above-mentioned transfer of engagement between the toe protrusion 208 and the heel protrusion 210 with the magazine 122, the spacing pins 144 abut the rear surface 400 of the magazine 122 in spaces 402 that lie between circumferentially spaced arcuate slots 404.

Turning to FIG. 5, as a result of the rupture of the first burst disc 232, the pressure of the helium gas, sometimes known as the “quench pressure”, eventually reduces to a level where the pressure of the helium gas in the internal chamber 132 of the pressure actuator 112 can no longer overcome the force of the second spring 142 coupled to the unlocking sear 140 via the piston 136. The second spring 142 therefore prevails and the piston 136 carrying the unlocking sear 140 is then withdrawn back to the rest position.

Once the ramped surface 226 of the unlocking sear 140 is, in this example, no longer in contact with the following surface 224 of the pivotable lever 200, the third spring 212 is able to prevail and urge the heel end 206 towards the magazine 122. Due to the pivotable nature of the pivotable lever 200, the toe protrusion 208 at the toe end 204 of the pivotable lever 200 withdraws from the second clearance 222, thereby disengaging the toe portion 208 from locking the magazine 122. At this stage, both the toe and heel protrusions 208, 210 are disengaged from the magazine 122. Of course, in another embodiment, the skilled person should appreciate that the ramped surface 226 of the unlocking sear 140 can reach a minimum point sufficient to achieve disengagement of the toe portion 208 without losing contact with the pivotable lever 200.

Thereafter (FIG. 6), as the magazine 122 is not locked in position, the magazine 122 starts to rotate under the power of the pre-tensioned first spring 146, a first dog 600 of the plurality of dogs 216 nearest the heel portion 206 of the pivotable lever 200 moves past the heel end 206 of the pivotable lever 200. Once the first dog 600 nearest the heel end 206 of the pivotable lever 200 clears the heel protrusion 210 of the pivotable lever 200, the force of the third spring 212 urges the heel protrusion 210 of the pivotable lever 200 into engagement with a first adjacent clearance 602 of the second clearances 222 of the magazine 122 at a base of a first ramp length 604 of the ramp lengths 218.

Referring to FIGS. 7 and 8, the magazine 122 continues to rotate causing the plurality of guiding pins 144 to overlie the respective circumferentially spaced slots 404. Additionally, the upper ramp surface 219 of the first ramp length 604 bears on an opposing surface 700 of the heel protrusion 210 of the pivotable lever 200, thereby urging the magazine 122 axially towards the backing disc 128 and hence the plurality of guiding pins 144 into the respective circumferentially spaced slots 404 because the guiding pins 144 now no longer prevent movement of the magazine 122 towards the backing disc 128. The first spring 146 is therefore compressed, allowing the magazine to move away from the second inlet port 110 and hence a second O-ring seal 702 fitted to a second burst disc 234 to be clear of the second inlet port 110 during movement into position of the second burst disc 234 so as not to foul the second O-ring seal 702 during replacement of discs. The biased bridging conduit 127 follows the translation of the magazine 122 by virtue of the dynamic O-ring seal.

Turning to FIG. 9, once the heel protrusion 210 of the pivotable lever 200 passes over the highest part 900 of the first ramp length 604, one of the main contributing factors to compression of the first spring 146 is no longer present, and so the first spring 146 forces urges the magazine 122 away from the backing disc 128 so as to return to the initial axial position and bring the second O-ring seal 702 (not shown in FIG. 9) of the second burst disc 234 into contact with the second inlet port 110. As the magazine 122 moves back to the initial axial position, the magazine 122 continues to rotate slightly bringing the plurality of guiding pins 144 into registry with the spaces 402 between the circumferentially spaced slots 404, thereby once again preventing the magazine 122 from moving axially towards the backing disc 128 when vented helium gas acts upon an in-use burst disc 234 of the magazine 122.

The magazine 122 having now indexed one position by performing one sixth of a revolution, has replaced the first ruptured burst disc 232 with the second burst disc 234, fully sealed and intact, so that the MRI system is ready to continue operation. The process of indexing the magazine 122 and hence replacement of the ruptured first burst disc 232 has been completed without any human intervention, the rotation having been triggered by a reciprocating cycle of the unlocking sear 140.

Although the above-described technique for indexing the magazine 122 is a purely mechanical implementation, the skilled person should appreciate that the magazine 122 can be made to rotate using an electrical motor, a hydraulic device, a pneumatic device or any other suitable drive implementation.

Whilst the above embodiment has been described in the context of helium being used as the cryogen of choice, the skilled person should appreciate that helium is not mandatory and other cryogens can be employed. Also, whilst the above embodiment has been described in the context of an MRI system, the embodiment can be employed in relation to any suitable tomography system, or indeed any suitable cryogen vessel.

1. A burst disc replacement apparatus comprising:
a magazine carrying a first burst disc and a second burst disc;
a flow path therethrough for venting fluid, the first burst disc being located in the flow path; and
a translation mechanism arranged to move the second burst disc into the flow path in place of the first burst disc in response to fluid pressure at one side of the first burst disc exceeding a predetermined pressure corresponding to rupture of the first burst disc.

2. An apparatus as claimed in claim 1, wherein the magazine is arranged to carry a plurality of burst discs including the first burst disc and the second burst disc.

3. An apparatus as claimed in claim 1, wherein the magazine is circular, the first and second burst discs being circumferentially spaced.

4. An apparatus as claimed in claim 1, wherein the magazine is windable.

5. An apparatus as claimed in claim 4, further comprising a mechanical stop for prevention of over-winding of the magazine.

6. An apparatus as claimed in claim 1, wherein the magazine comprises a plurality of circumferentially extending slopes spaced between a plurality of circumferentially spaced dogs.

7. An apparatus as claimed in claim 6, further comprising a pivotable lever, the pivotable lever having a toe protrusion and a heel protrusion.

8. An apparatus as claimed in claim 7, further comprising a biasing device, the biasing device being arranged with the pivotable lever so as to urge the heel protrusion of the pivotable lever towards a periphery of the magazine.

9. An apparatus as claimed in claim 1 further comprising:
an ingress port disposed on one side of the magazine; and
a further biasing device arranged to urge the magazine towards the ingress port.

10. An apparatus as claimed in claim 9, wherein the pivotable lever is arranged to cooperate with a slope of the plurality of slopes in order to overcome the further biasing device.

11. An apparatus as claimed in claim 9, wherein the further biasing device is arranged to bias the magazine in two directions.

12. An apparatus as claimed in claim 9, wherein the further biasing device is arranged to bias the magazine axially and rotationally.

13. An apparatus as claimed in claim 1, further comprising a backing plate disposed substantially parallel with the magazine and comprising circumferentially spaced pins extending from the backing plate to the magazine.

14. An apparatus as claimed in claim 13, wherein the magazine comprises a plurality of circumferentially spaced slots disposed opposite the backing plate for temporarily receiving the circumferentially spaced pins during replacement of the first burst disc.

15. An apparatus as claimed in claim 1, wherein the magazine is mounted on a spindle.

16. An apparatus as claimed in claim 1, further comprising a pressure actuator responsive to the fluid pressure at the one side of the first burst disc exceeding the predetermined pressure corresponding to rupture of the first burst disc.

17. An apparatus as claimed in claim 16, wherein the pressure actuator is fluidly coupled to the flow path on the one side of the first burst disc.

18. An apparatus as claimed in claim 16, wherein the pressure actuator is mechanically actuatable.

19. An apparatus as claimed in claim 16, wherein the pressure actuator comprises a piston coupled to a triggering protrusion arranged to translate linearly with the piston.

20. An apparatus as claimed in claim 19, wherein a reciprocating cycle of the triggering protrusion triggers the magazine to rotate so as to replace the first burst disc with the second burst disc.

21. An apparatus as claimed in claim 4, wherein the magazine comprises a broken circular groove to serve as the end stop.

22. An apparatus as claimed in claim 1, further comprising:
an egress port fluidly coupled to atmosphere or a fluid reclamation unit, the magazine being sealingly coupled to the egress port.

23. A magnetic resonance imaging system comprising the burst disc replacement apparatus as claimed in claim 1.
